(19) United States
(12) Patent Application Publication
(10) Pub. No.: US 2025/0292393 A1
(43) Pub. Date: Sep. 18, 2025

(54) CONDITION DEFINITION APPARATUS, CONDITION DEFINITION METHOD, AND CONDITION DEFINITION PROGRAM

(71) Applicant: NEC Corporation, Tokyo (JP)

(72) Inventors: Gaku NAKANO, Tokyo (JP); Powei LIAO, Tokyo (JP)

(73) Assignee: NEC Corporation, Tokyo (JP)

(21) Appl. No.: 19/027,237

(22) Filed: Jan. 17, 2025

(30) Foreign Application Priority Data
Mar. 18, 2024 (JP) 2024-042224

(51) Int. Cl. G06T 7/00; G06V 10/44

(52) U.S. Cl. CPC G06T 7/0008; G06V 10/44; G06T 2207/30108

(57) ABSTRACT

A condition definition apparatus includes: accepting first inspection object data showing an image of a first inspection object; summary text data explaining a summary of condition of the inspection object in text, and detailed text data explaining details of condition of the inspection object in text, generating an image feature vector showing features of the image shown by the first inspection object data from the accepted first inspection object data, generating a summary feature vector showing summary of features of the condition of the inspection object shown by the summary text data from the accepted summary text data, generating an integrated feature vector by integrating the generated summary feature vector and generating the detailed feature vector and inspection object class data used to define the condition of the inspection object from the integrated feature vector.

### FIELD

### CROSS REFERENCE TO RELATED APPLICATION

The present invention is based on the priority claim of Japanese Patent Application No. 2024-042224 (filed on Mar. 18, 2024), the entire contents of which are incorporated herein by reference. The present invention relates to a condition definition apparatus, a condition definition method, and a condition definition program.

### BACKGROUND

In transportation infrastructure such as bridges and tunnels (hereinafter, described as “infrastructure”), early detection of damage such as cracks and corrosion is important for long-term maintenance. On the other hand, visual inspection can lead to oversights due to individual differences in the ability of inspectors. Patent Literature (PTL) 1 discloses a method for quantitatively detecting damage from images taken by a camera.

A method called CLIP (Contrastive Language-Image Pre-training) is also known that learns images and summary texts that explain the images, and classifies the object classes in the images. In CLIP, it is known that slight differences in the summary text can have a large effect on classification accuracy. For example, when an image of a dog is given a summary such as “a photo of a dog” or “an image of a dog,” the classification results will be significantly different, even if the meaning of the summary is substantially the same. Further, a method called DualCoOp (Dual Context Optimization) is also known for such applications.

PTL 1: JP 2023-168548 A

### SUMMARY

The disclosure of the above prior art document is incorporated by reference into this document. The following analysis is given by the inventors.

However, the method disclosed in PTL 1 defines damages by processing images of the damages such as cracks and corrosions (damage images). But, such methods do not always correctly define the damages because definitions of damages related to actual inspections are not used in image processing. Further, CLIP and DualCoOp are sensitive to slight differences in the summary text attached to the image, and the definitions of the damages may change significantly even if a summary text with substantially the same meaning is attached to the same damage. Therefore, these methods are not suitable for class classification to define the damage images.

In view of the above problems, it is an object of the present invention to contribute to machine learning for defining a condition of an inspection object, such as a damage, and to define a condition of an inspection object, such as a damage, using learning results of this machine learning

In a first aspect of the present invention, there is provided a condition definition apparatus including one or more processors for defining a condition of an inspection object. The one or more processors are configured to: accept first inspection object data showing an image of a first inspection object, summary text data explaining a summary of a condition of the inspection object in text, and detailed text data explaining details of the condition of the inspection object in text; generate an image feature vector showing features of the image shown by data of the first inspection object from the accepted first inspection object data; generate a summary feature vector showing a summary of features of the condition of the inspection object shown by the summary text data from the accepted summary text data; generate a detailed feature vector showing details of the condition of the inspection object shown by the detailed text data from the accepted detailed text data; generate an integrated feature vector by integrating the generated summary feature vector and the detailed feature vector; and generate inspection object class data used to define the condition of the inspection object from the integrated feature vector.

In a second aspect of the present invention, there is provided a condition definition method including: accepting first inspection object data showing an image of a first inspection object, summary text data explaining a summary of a condition of the inspection object in text, and detailed text data explaining details of the condition of the inspection object in text; generating an image feature vector showing features of the image shown by data of the first inspection object from the accepted first inspection object data; generating a summary feature vector showing a summary of features of the condition of the inspection object shown by the summary text data from the accepted summary text data, generating a detailed feature vector showing details of the condition of the inspection object shown by data of the detailed text from the accepted detailed text data; generating an integrated feature vector by integrating the generated summary feature vector and the detailed feature vector; and generating inspection object class data used to define the condition of the inspection object from the integrated feature vector.

In a third aspect of the present invention, there is provided a condition definition program that causes a computer to execute processes including: accepting first inspection object data showing an image of a first inspection object, summary text data explaining a summary of a condition of the inspection object in text, and detailed text data explaining details of the condition of the inspection object in text; generating an image feature vector showing features of the image shown by data of the first inspection object from the accepted first inspection object data; generating a summary feature vector showing a summary of features of the condition of the inspection object shown by the summary text data from the accepted summary text data; generating a detailed feature vector showing details of the condition of the inspection object shown by the detailed text data from the accepted detailed text data; generating an integrated feature vector by integrating the generated summary feature vector and the detailed feature vector; and generating inspection object class data used to define the condition of the inspection object from the integrated feature vector. Note that, the program may be recorded in a computer-readable storage medium. The storage medium may be a non-transitory medium such as a semiconductor memory, a hard disk, a magnetic recording medium, an optical recording medium, etc. The present invention may be realized as a computer program product.

Each aspect of the present invention can contribute to machine learning for defining the condition of an inspection object, such as a damage, and to define the condition of an inspection object, such as damages, using learning results of this machine learning.

### BRIEF DESCRIPTION OF DRAWINGS

FIG. 1 is a diagram illustrating an example configuration of a condition definition apparatus according to the present disclosure.

FIG. 2 is a diagram illustrating an example of a hardware configuration of an information processing apparatus that executes a program when the condition definition apparatus shown in FIG. 1 is realized as a program.

FIG. 3 is a flowchart illustrating an example of a machine learning operation of the condition definition apparatus shown in FIG. 1.

FIG. 4 is a flowchart illustrating an example of the operation to associate damage class data with input damage image data and output them.

FIG. 5 is a diagram illustrating an example configuration of a condition definition apparatus according to the present disclosure.

FIG. 6 is a flow chart illustrating another example of the machine learning operation of the condition definition apparatus shown in FIG. 4

### EXAMPLE EMBODIMENTS

### First Example Embodiment

A first example embodiment of the present disclosure will be described below with reference to the drawings. Note that, the present disclosure is not limited to the example embodiments described below. Further, each drawing is schematic, and the same or corresponding elements, processes, and communications are appropriately assigned the same reference numerals.

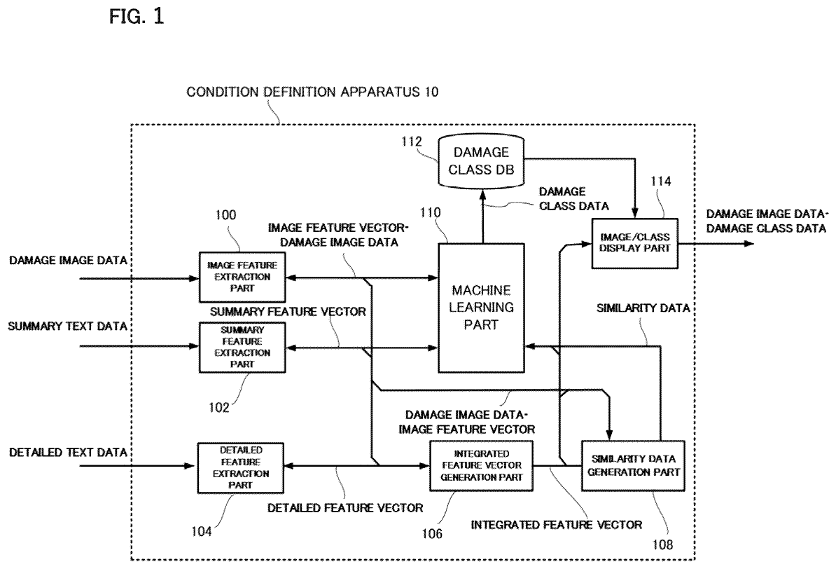

FIG. 1 is a diagram illustrating a n example configuration of a condition definition apparatus 10 according to the present disclosure. As shown in FIG. 1, the condition definition apparatus 10 includes an image feature extraction part 100, a summary feature extraction part 102, a detailed feature extraction part 104, an integrated feature vector generation part 106, a similarity data generation part 108, a machine learning part 110, a damage class database (damage class DB (Data Base)) 112, and an image/class display part 114.

All or some of the components of the condition definition apparatus 10 may be realized by dedicated hardware. Alternatively, they may be realized by a combination of hardware and software such as a program that runs on a computer's OS (Operating System). Further, alternatively, they may be realized by software that runs on the OS of an information processing apparatus.

In the following, for the sake of concreteness and clarity of the description, a specific example will be given in which the condition definition apparatus 10 defines damages that have occurred to an inspection object, such as concrete walls or bolts contained in transportation infrastructure such as bridges or tunnels. On the other hand, in addition to defining such a damage(s), the condition definition apparatus 10 can be applied to defining various event(s), such as defining a condition(s) other than the damage(s) to inspection object(s), defining meteorological phenomena, defining engineering/scientific event(s), defining biological event(s), and defining geological event(s).

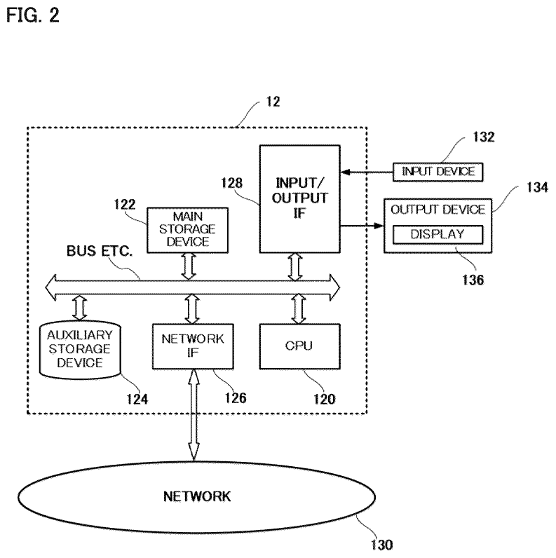

FIG. 2 is a diagram illustrating an example of a hardware configuration of an information processing apparatus (computer) 12 that executes a program(s) when the condition definition apparatus 10 shown in FIG. 1 is realized as a program(s). When all of the components of the condition definition apparatus 10 are realized in software as a program(s) that runs on the OS of the information processing apparatus, such a program(s) can be executed, for example, by the information processing apparatus 12 illustrated in FIG. 2. Note that, the hardware configuration of the information processing apparatus 12 shown in FIG. 2 is no more than an example, and does not limit the hardware configuration of the information processing apparatus 12. In addition, the information processing apparatus 12 can further include component(s) not shown in FIG. 2. As shown in FIG. 2, the information processing apparatus 12 includes a CPU(s) (Central Processing Unit(s); processor(s)) 120, a main storage device 122, an auxiliary storage device 124, a network interface (network IF (InterFace)) 126, and an input/output interface (input/output IF) 128, that are connected via a bus and wiring, etc. so that they can input and output data to each other.

In the information processing apparatus 12, the CPU(s) 120 executes instructions contained in a program(s) for realizing the function(s) of each component of the condition definition apparatus 10. The main storage device 122 includes memory devices such as RAM(s) (Random Access Memory(Memories)) and ROM(s) (Read Only Memory(Memories)). The main storage device 122 stores, in its storage devices, a program including instructions to be executed by the CPU(s) 120, as well as data required for executing this (these) program(s).

The network interface 126 has a function of connecting the CPU(s) 120 of the information processing apparatus 12 to a network 130 such as a local area network (LAN), a wide area network (WAN), or a mobile wireless system such as 5G (5th Generation) so as to enable data communication The CPU(s) 120 can communicate data with other information processing apparatus (not shown) connected to the network 130 via the network interface 126 and the network 130.

The auxiliary storage device 124 includes a non-volatile storage device(s) such as a hard disk drive(s) (HDD(s)), a solid condition drive (SSD(s)), and a flash memory(memories) (not shown). The auxiliary storage device 124 stores program(s) for realizing the function(s) of each component of the condition definition apparatus 10, as well as data required for its(their) execution, in a non-volatile storage device(s) for the medium to long term. The auxiliary storage device 124 may comprise a connector(s) to which a non-volatile memory(memories) and a cable(s) can be connected, such as a connector(s) for a USB (Universal Serial Bus).

A program(s) of realizing the function(s) of each component of the condition definition apparatus 10 may be provided to the information processing apparatus 12 from another(other) information processing apparatus via the network 130 and the network interface 126. Alternatively, this(these) program(s) may be provided to the information processing apparatus 12 from another(other) information processing apparatus connected by a cable(s) via a connector(s) of the auxiliary storage device 124. Alternatively, this(these) program(s) may be provided to the information processing apparatus 12 as a program product(s) recorded on a non-transitory computer-readable storage medium(media) such as a USB memory(memories), CD-ROM(s), or DVD(s) (all not shown). In addition, data, etc. may be written to a non-volatile storage medium(s) such as a USB memory(memories) via the connector(s) of the auxiliary storage device 124.

An input device 132, such as a keyboard and a mouse, may be connected to the input/output interface 128 for receiving information showing a user's operation(s) in response to operation(s) by the user(s) of the condition definition apparatus 10. An output device 134, including a display 136 for displaying information generated by the condition definition apparatus 10, may also be connected to the input/output interface 128. The input/output interface 128 outputs information received by the input device 132 to the CPU(s) 120, and outputs or displays information generated by the condition definition apparatus 10 to the user(s). The following description illustrates an example in which the condition definition apparatus 10 is realized by a program(s) executed on an OS running on the information processing apparatus 12.

The components of the condition definition apparatus 10 will be described with reference again to FIG. 1. The image feature extraction part 100 of the condition definition apparatus 10 accepts damage image data indicative of (a) damage(s), and accepts image feature extraction parameter(s) from the machine learning part 110. The damage(s) include(s) crack(s), corrosion(s), fissure(s), peeling(s), and exposed rebar(s) in each of multiple inspection object(s) included in infrastructure equipment(s). The damage image(s) is (are) still image(s), moving image(s), or video(s) of the damage(s) recorded by an inspector using a camera. The damage image data are generated, for example, by photographing the damages with a digital camera connected as an input device 132 to the input/output interface 128 (FIG. 2). Note that, the damage image data may also be collected from the network 130 by the image feature extraction part 100.

The image feature extraction part 100 performs image processing on the damage image data using a neural network with image feature extraction parameters, for example, converts the damage image data into a numerical vector, and extracts an image feature vector. Note that, global features using ResNet (Residual Network) or HoG (Histogram of Oriented Gradients) can also be used to generate an image feature vector from the damage image data.

Further, the image feature extraction part 100 outputs the image feature vector and the damage image data to the machine learning part 110.

The summary feature extraction part 102 accepts summary text data indicating summary explanatory text(s) corresponding to the damage image data accepted by the image feature extraction part 100, and accepts summary feature extraction parameter(s) from the machine learning part 110. The summary text data are generated, for example, in response to a user's operation on a keyboard included in the input device 132 connected to the input/output interface 128 (FIG. 2). Alternatively, the summary text data may be collected, for example, from the network 130 by the summary feature extraction part 102.

The summary explanatory text(s) is (are) natural language text(s) prepared for inspectors by an expert(s) of infrastructure object damage(s) to be inspected, etc., and qualitatively explain(s) summary of the damage(s) shown in the damage image data. For example, when the damage image shows “cracks” as a damage, the summary explanatory text may be “a photo of cracks” or like. Note that, in this summary explanatory text, “a photo of” may be “an image of”. Further, for example, when the damage image shows “vertical cracks” as the damage, the summary explanatory text may be “a photo of a vertical crack”. Furthermore, for example, when the damage image shows “hexagonal cracks” as the damage, the summary explanatory text may be “a photo of alligator cracks”.

The summary feature extraction part 102 generates a summary feature vector(s) by converting character strings indicated by the received summary text data into a numerical vector(s). The summary feature extraction part 102 outputs the generated summary feature vector(s) to the integrated feature vector generation part 106. Note that, the conversion(s) from the character strings of the summary text data to the numerical vector(s) is (are) performed, for example, by processing using a neural network to which summary feature extraction parameters are applied. Alternatively, this (these) conversion(s) can be performed by a text encoder or a learner (learning device or machine) such as an SVM (Support Vector Machine).

The detailed feature extraction part 104 accepts detailed text data indicating detailed explanatory text(s) corresponding to the damage image data accepted by the image feature extraction part 100, and accepts detailed feature extraction parameter(s) from the machine learning part 110. The detailed text data are generated in response to the user's(users') operation(s) on a keyboard included in the input device 132 connected to the input/output interface 128 (FIG. 2). Alternatively, the detailed text data may be collected by the detailed feature extraction part 104 from the network 130.

The detailed explanatory text(s) is (are) natural language text(s) prepared for inspectors by an expert(s) of infrastructure object damage(s) to be inspected, etc. in natural language, and qualitatively explain the details of the damage(s) shown in the damage image data. For example, when the damage image shows “cracks” as the damage, the detailed explanatory text can be “Elongated and narrow zigzag line. Clearly darker compared to the surrounding area or black.” When the damage image shows “hexagonal cracks” as the damage, the detailed explanatory texts can be “Many branched cracks. Mostly arbitrarily orientated. Usually with a small crack width.”, etc. When the damage image shows “Concrete Corrosion” as the damage, the detailed explanatory text could be, “Includes the visually similar defects: Washouts, Concrete corrosion and generally all kinds of planar corrosion/erosion/abrasion of concrete. Concrete corrosion can appear as a result of frost-thaw cycles, loss in succession to chemical attacks or abrasion (mechanical or action of acid and salt solutions),” etc.

The detailed feature extraction part 104 generates a detailed feature vector(s) by converting the character strings indicated by the received detailed text data into a numerical vector(s). The detailed feature extraction part 104 outputs the generated detailed feature vector(s) to the integrated feature vector generation part 106. Note that, the conversion(s) from the character strings indicated by the detailed text data to a numerical vector(s) is (are) performed, for example, by processing using a neural network to which the detailed feature extraction parameters are applied, similar to the conversion from character strings to a numerical vector(s) in the summary feature extraction part 102. Alternatively, this conversion can be performed by a learner (learning device or machine) such as a text encoder or SVM.

The integrated feature vector generation part 106 accepts the summary feature vector(s) from the summary feature extraction part 102, and accepts the detailed feature vector(s) from the detailed feature extraction part 104. The integrated feature vector generation part 106 generates a n integrated feature vector(s) by integrating the accepted summary feature vector(s) and the accepted detailed feature vector(s), and outputs them to the similarity data generation part 108 and the image/class display part 114. Note that, the integration of the summary feature vector and the detailed feature vector involves converting this (these) vector(s) into a single integrated feature vector, and this integration can be achieved, for example, by simply concatenating this (these) vector(s) together, or by processing using a transformer-type neural network (multi-head attention module).

The similarity data generation part 108 accepts the image feature vector(s) from the image feature extraction part 100, and accepts the integrated feature vector(s) from the integrated feature vector generation part 106. The similarity data generation part 108 calculates the similarity (similarities) between the accepted image feature vector(s) and the integrated feature vector(s), generates similarity data indicating the calculated similarity (similarities), and outputs it(them) to the machine learning part 110.

The machine learning part 110 accepts the integrated feature vector(s) from the integrated feature vector generation part 106, and accepts similarity data from the similarity data generation part 108. The image feature extraction part 100 learns by adjusting the numerical values contained in the image feature extraction parameters, summary feature extraction parameters, and the detailed feature extraction parameters so as to maximize the similarity between the integrated feature vector(s) indicated by the similarity data and the image feature vector(s). The machine learning part 110 maximizes the similarities between the integrated feature vector(s) indicated by the similarity data and the image feature vector(s) by using processes such as Stochastic Gradient Descent (SGD), Adaptive moment estimation (Adam), or Adaptive Gradient Algorithm (AdaGrad).

The machine learning part 110 outputs the image feature extraction parameter(s) with adjusted value(s) to the image feature extraction part 100. The machine learning part 110 also outputs the general feature extraction parameter(s) with adjusted value(s) to the summary feature extraction part 102. The machine learning part 110 also outputs the detailed feature extraction parameter(s) with adjusted value(s) to the detailed feature extraction part 104. The machine learning part 110 further processes the image feature vector(s), and generates damage class data indicating numbers, symbols, etc. for defining the damages corresponding to the image feature vector(s). The machine learning part 110 associates the generated damage class data with the integrated feature vector(s) and the image feature vector(s), and outputs them to the damage class database 112. Note that, the number of damage class data, the number of integrated feature vectors, and the number of image feature vectors are equal.

The damage class database 112 stores the damage class data input from the machine learning part 110 in association with the integrated feature vector(s) corresponding to this damage class data. To generate damage class data from the image feature vector(s), for example, a trained neural network such as MLP (Multi-Layer Perceptron) or Transformer is used. This learning is performed, for example, by adjusting the parameters used to generate damage class data from the image feature vectors so that the similarities between the integrated feature vectors and the feature vectors generated from the damage class data are maximized.

The image/class display part 114 accepts the integrated feature vector(s) from the integrated feature vector generation part 106. The image/class display part 114 executes search in the damage class database 112 using the accepted integrated feature vector(s), and outputs the damage class data and damage image data associated with the integrated feature vector(s) to the display 136 of the output device 134 via the input/output interface 128 (FIG. 2). The display 136 displays the input damage class data and damage image data to the user(s).

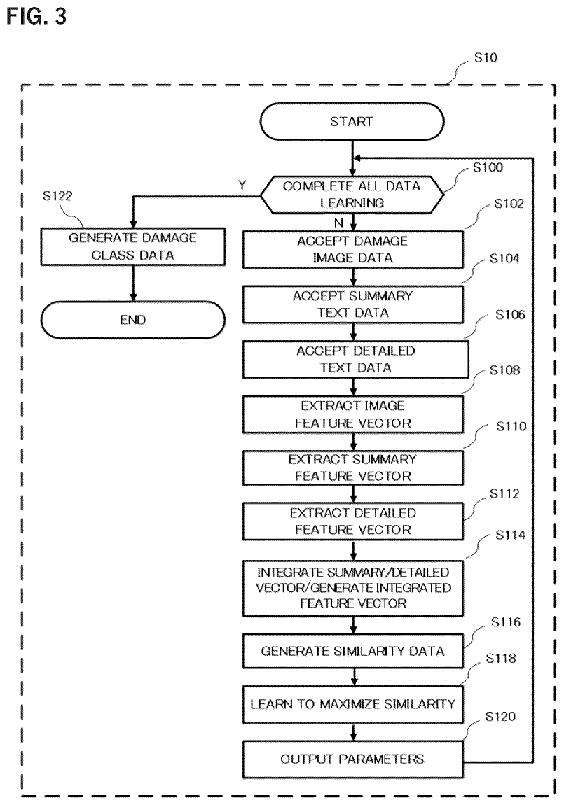

Next, the machine learning operation(s) of the condition definition apparatus 10 will be described. FIG. 3 is a flowchart illustrating an example of the machine learning operation(s) (S10) of the condition definition apparatus 10 shown in FIG. 1. Note that in the machine learning operation(s) of the condition definition apparatus 10, the image/class display part 114 does not function.

In S100, the condition definition apparatus 10 determines whether or not learning has been completed using all of the damage image data, summary text data and detailed text data. When the learning has been completed using all of the damage image data, summary text data. and detailed text data (Y in S100), the condition definition apparatus 10 proceeds to processing of S122. When the learning has not been completed using all of the damage image data, summary text data, and detailed text data (N in S100), the condition definition apparatus 10 proceeds to processing of S102.

In S102, the image feature extraction part 100 accepts damage image data that has not previously been the subject of machine learning. In S104, the summary feature extraction part 102 accepts summary text data corresponding to the damage image data accepted in the processing of S102. In S106, the detailed feature extraction part 104 accepts detailed text data corresponding to the damage image data accepted in the processing of S102.

In S108, the image feature extraction part 100 extracts an image feature vector from the damage image data based on the image feature extraction parameters input from the machine learning part 110, and outputs it to the integrated feature vector generation part 106, the similarity data generation part 108, and the machine learning part 110. In S110, the summary feature extraction part 102 extracts a summary feature vector from the summary text data based on the summary feature extraction parameters input from the machine learning part 110, and outputs it to the integrated feature vector generation part 106. In S112, the detailed feature extraction part 104 extracts a detailed feature vector from the detailed text data based on the detailed feature extraction parameters input from the machine learning part 110, and outputs it to the integrated feature vector generation part 106.

In S114, the integrated feature vector generation part 106 generates an integrated feature vector by integrating the features of the summary explanatory text indicated by the summary feature vector and the features of the detailed explanatory text indicated by the detailed feature vector, and outputs it to the similarity data generation part 108. In S116, the similarity data generation part 108 calculates the similarity between the image feature vector input from the image feature extraction part 100 and the integrated feature vector input from the integrated feature vector generation part 106, and outputs similarity data indicating the calculated similarity to the machine learning part 110.

In S118, learning is performed by adjusting the numerical values contained in the image feature extraction parameters, summary feature extraction parameters, and the detailed feature extraction parameters so as to maximize the similarity between the image feature vector and the integrated feature vector. In S120, the machine learning part 110 outputs each of these parameters to the image feature extraction part 100, the summary feature extraction part 102 and the detailed feature extraction part 104, respectively.

The processing loop of S100 to S118 ends, for example, when processing of all damage image data, their summary text data, and their detailed text data have been completed. Further, alternatively, this processing loop may end when this processing loop has been repeated a predetermined number of times. Furthermore, alternatively, this processing loop may end when the change in the similarities between the image feature vector(s) and the integrated feature vector(s) becomes minimal and it is determined that the similarities between the image feature vector(s) and the integrated features vector have converged.

In S122, the machine learning part 110 generates damage class data, associates the generated damage class data with the integrated feature vector(s), and outputs the associated data to the damage class database 112. The damage class database 112 stores the damage class data, integrated feature vector(s), and image feature vector(s) input from the machine learning part 110 in association with each other, and then ends the process.

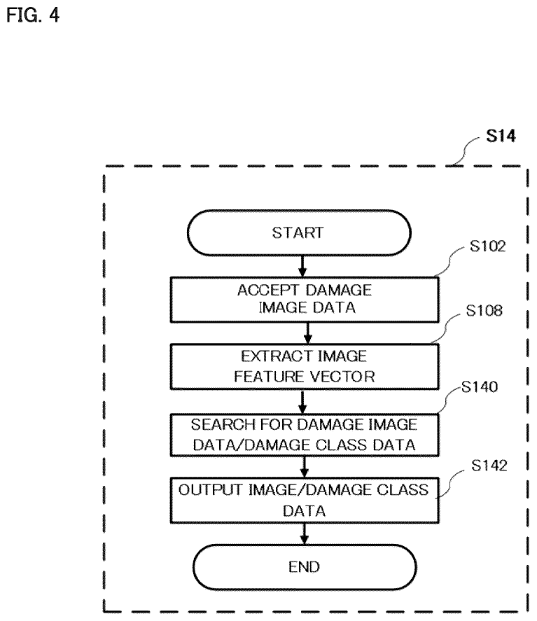

Next, the operation of the condition definition apparatus 10 to associate damage class data with input damage image data, and to output them will be described. In this operation, the similarity data generation part 108 and the machine learning part 110 do not function, but the image/class display part 114 functions. FIG. 4 is a flowchart illustrating an example of the operation (S14) to associate damage class data with input damage image data and output them.

As shown in FIG. 4, first, the condition definition apparatus 10 performs S102 and S110 described with reference to FIG. 3, and generate image feature vector(s) corresponding to the input damage image data.

In S140, the image/class display part 114 searches for damage class data and image feature vector(s) stored in the damage class database 112 using the integrated feature vector(s) generated by the processes of S102 to S114. This search obtains damage class data associated with the image feature vector(s) that has(have) the highest similarity (similarities) to the generated image feature vector(s). In S142, the image/class display part 114 outputs the damage class data and damage image data obtained by the search in the process of S140 to the output device 134 via the input/output interface 128 That is, for example, the display 136 of the output device 134 displays the damage image data output from the image/class display part 114 and the definitions of damages given by the damage class data, and shows them to the user.

According to the condition definition apparatus 10 of the present disclosure as explained above, damages can be defined by numbers and symbols indicated by damage class(es) based on damage image(s), summary explanatory text(s) describing the damage(s) in summary, and detailed explanatory text(s) describing the damage(s) in detail. That is, summary classification(s) of the damage(s) shown by the damage image(s) can be performed using the summary feature extraction part 102, and a detailed classification(s) of the damage(s) shown by the damage images can be performed using the detailed feature extraction part 104. In this way, the condition definition apparatus 10 can qualitatively learn the damages shown by the damage images through machine learning using summary data on the damages and detailed data on the damages, i.e., through the machine learning using multiple data with different granularities.

### Second Example Embodiment

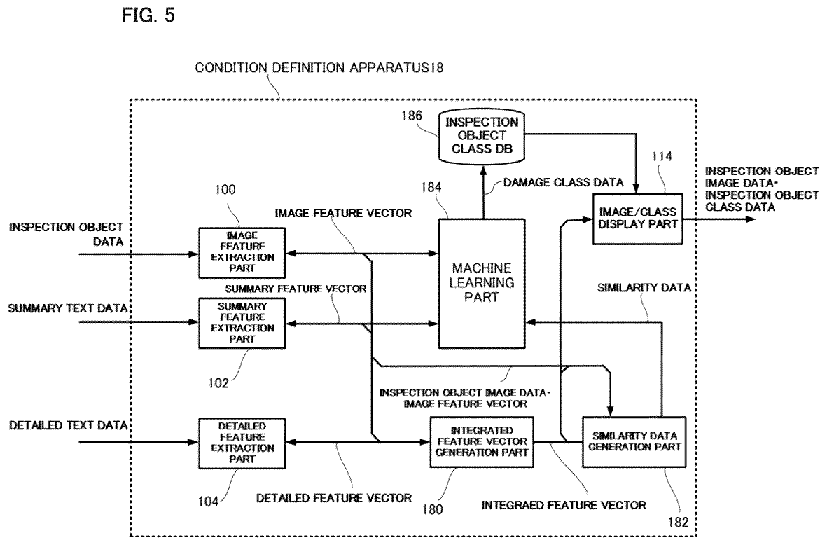

A second example embodiment of the present disclosure will be described below. FIG. 5 is a diagram illustrating example configuration of a condition definition apparatus 18 according to the present disclosure. The condition definition apparatus 18 has a configuration in which the integrated feature vector generation part 106, the similarity data generation part 108, the machine learning part 110 and the damage class database 112 of the condition definition apparatus 10 shown in FIG. 1 are replaced with an integrated feature vector generation part 180, a similarity data generation part 182, a machine learning part 184 and an inspection object class database 186, respectively.

As shown in FIG. 5, instead of the damage image data input to the condition definition apparatus 10, inspection object data different from the damage image data that are the subject of machine learning shown in FIG. 3 are input to the image feature extraction part 100 of the condition definition apparatus 18. Note that, the inspection object data and the inspection object class data below differ from the damage image data and damage class data only in names that are changed for the sake of explanation, and in whether or not they have been the subjects of machine learning shown in FIG. 3. These data are substantially the same, and the processing of the inspection object data and the inspection object class data is the same as the processing of the damage image data and the damage class data.

Note that, for the sake of concreteness and clarity of the description, in the second example embodiment, a case will be described in which the condition definition apparatus 18 performs machine learning on one inspection object data and N sets of summary text data and detailed text data corresponding to these inspection object data. Accordingly, in the second example embodiment, the number of summary text data and the number of detailed text data input to the condition definition apparatus 18 are the same, but the number of the inspection object data and the number of summary text data and detailed text data are not necessarily the same It goes without saying that the condition definition apparatus 18 can perform machine learning on each of the multiple inspection object data and the N sets of summary text data and detailed text data corresponding to this inspection object data. It also goes without saying that the condition definition apparatus 18 can perform machine learning on the multiple inspection object data obtained by photographing one inspection object over time.

The inspection object data shows, for example, images of a plurality of inspection objects taken after machine learning has been performed on the damage image data, summary text data, and detailed text data using machine learning as shown in FIG. 3. Therefore, inspection object data are not subject to machine learning by the condition definition apparatus 18 shown in FIG. 3 before being input to the condition definition apparatus 18.

The integrated feature vector generation part 180 performs the same processing as the integrated feature vector generation part 106 (FIG. 1). The integrated feature vector generation part 180 further accepts N sets of general feature vectors and the detailed feature vector(s) corresponding to one inspection object data from the summary feature extraction part 102. The integrated feature vector generation part 180 integrates the general feature vectors and the detailed feature vector(s) of each of the N sets accepted, generates N types of integrated feature vectors, and outputs them to the similarity data generation part 182.

The similarity data generation part 182 performs the same processing as the similarity data generation part 108 (FIG. 1). The similarity data generation part 182 further calculates the similarities between the N types of integrated feature vectors and one inspection object data corresponding to these N types of integrated feature vectors, generates similarity data indicating the calculated similarities, and outputs them to the machine learning part 184.

The machine learning part 184 performs the same processing as the machine learning part 110 (FIG. 1). Note that, in the processing of the machine learning part 110 by the machine learning part 184, the damage image data and damage class data, etc. are replaced with inspection object data and inspection object class data, etc. The machine learning part 184 further accepts the N types of integrated feature vectors corresponding to one piece of inspection object data from the integrated feature vector generation part 180, and accepts similarity data from the similarity data generation part 182. The image feature extraction part 100 performs machine learning by adjusting the numerical values included in the image feature extraction parameters, summary feature extraction parameters, and the detailed feature extraction parameters so as to maximize the similarities between the N types of integrated feature vectors indicated by the similarity data and the image feature vector(s) corresponding to the inspection object data.

The inspection object class database 186 performs the same processing as the damage class database 112 on the image feature vector(s) obtained from the inspection object data, the integrated feature vector(s) obtained from the summary feature vector(s), and detailed feature vector(s) corresponding to the inspection object data, and the inspection object class data used to define the condition of the inspection object shown by the inspection object data. That is, the inspection object class database 186 stores the image feature vector(s), integrated feature vector(s), and inspection object class data in association with each other. The inspection object class database 186 further stores the N types of the integrated feature vector(s) input from the integrated feature vector generation part 180, and the inspection object class data input from the machine learning part 184 in association with each other.

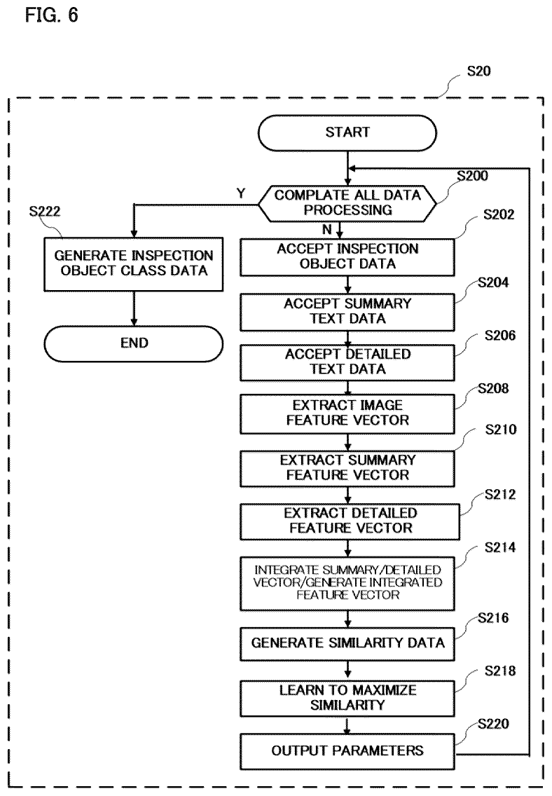

Next, a machine learning operation of the condition definition apparatus 18 will be described. FIG. 6 is a flow chart illustrating another example (S20) of the machine learning operation of the condition definition apparatus 18 shown in FIG. 4. Note that in the machine learning operation of the condition definition apparatus 18, the image/class display part 114 does not function. Further, the operation of outputting the inspection object data (damage image data) in association with the inspection object class data (damage class data) used to define the condition of the inspection object based on the result of the machine learning process shown in FIG. 6 is the same as that described with reference to FIG. 4, and therefore will not be described here. Note that, in this case, in the description of FIG. 4, it is necessary to replace the integrated feature vector generation part 106 with the integrated feature vector generation part 180, the similarity data generation part 108 with the similarity data generation part 182, and the machine learning part 110 with the machine learning part 184. Furthermore, they are necessary to replace the damage class data with the inspection object class data, and to replace the damage image data with the inspection object image data.

As shown in FIG. 6, in S200, the condition definition apparatus 18 determines whether or not learning has been completed using one inspection object data, all of the N sets of summary text data, and detailed text data corresponding to this inspection object data. When the learning has been completed using all of the damage image data, the summary text data, and the detailed text data (Y in S200), the condition definition apparatus 18 terminates the machine learning operation after processing S222 below. When learning has not been completed using all of the damage image data, summary text data, and detailed text data (N in S200), the condition definition apparatus 18 proceeds to processing S202.

In S202, the image feature extraction part 100 accepts the inspection object data that have previously been the subject of the machine learning shown in FIG. 3, and have not previously been the subject of the machine learning shown in FIG. 6. In S204, the summary feature extraction part 102 accepts N types of summary text data corresponding to the inspection object data accepted in the processing of S202. In S206, the detailed feature extraction part 104 accepts N types of detailed text data corresponding to the inspection object data accepted in the processing of S202.

In S208, the image feature extraction part 100 extracts the image feature vector(s) from the inspection object data based on the image feature extraction parameters input from the machine learning part 184, and outputs them to the integrated feature vector generation part 180, the similarity data generation part 182 and the machine learning part 184. In S210, the summary feature extraction part 102 extracts the N types of summary feature vectors from the N types of summary text data based on the summary feature extraction parameters input from the machine learning part 184, and outputs them to the integrated feature vector generation part 180. In S212, the detailed feature extraction part 104 extracts N types of detailed feature vectors from N types of detailed text data based on the detailed feature extraction parameters input from the machine learning part 184, and outputs them to the integrated feature vector generation part 180.

In S214, the integrated feature vector generation part 180 integrates the N sets of general feature vectors and detailed feature vectors, generates the N types of integrated feature vectors indicating the integrated features, and outputs them to the similarity data generation part 182. In S216, the similarity data generation part 182 calculates the similarities between the image feature vectors generated from the inspection object data by the image feature extraction part 100 and the N types of integrated feature vectors input from the integrated feature vector generation part 180, and outputs the N types of similarity data indicating the calculated similarities to the machine learning part 184.

In S218, learning is performed by adjusting the numerical values contained in the image feature extraction parameters, summary feature extraction parameters, and the detailed feature extraction parameters so as to maximize the similarities between the image feature vector(s) and the N types of integrated feature vectors. In S220, the machine learning part 184 outputs each of these parameters to the image feature extraction part 100, summary feature extraction part 102 and detailed feature extraction part 104, respectively.

In S222, the machine learning part 184 generates inspection object class data and outputs the generated inspection object class data to the inspection object class database 186 in association with the integrated feature vectors. The inspection object class database 186 stores the damage class data input from the machine learning part 184 in association with the integrated feature vectors. By performing the machine learning shown in FIG. 6, an event(s) such as a damage(s) occurring to a single inspection object is (are) defined from multiple perspectives, increasing the versatilities of the inspection object class database 186.

### Modifications

Modifications of the example embodiments of the present disclosure will be described below. The image/class display part 114 reads out, from the damage class database 112 (inspection object class database 186), the damage class data (inspection object class data) associated with the integrated feature vector(s) input from the similarity data generation part 108 (182) and the integrated feature vector(s) having a similarity of a predetermined threshold value (e.g., 80%) or more, and can display it to the user together with the damage image data (inspection object data). Note that, here, there is no substantial difference between “above threshold” and “larger than threshold”. By modifying the operation of the image/class display part 114 in this way, the condition definition apparatus 10 (18) can obtain one or more types of damage class data (inspection object class data) as a search result based on one input damage image data (inspection object data), and display them to the user together with the input damage image data (inspection object data).

Further, the process of S140 shown in FIG. 4 may be executed in advance using the condition definition apparatuses 10 and 18, and then the processes of S102, S110, and S142 may be executed. For example, by inputting a large amount of damage image data into the condition definition apparatus 10 and 18 in advance, and searching for damage class data (inspection object class data), the amount of processing in S102, S110, and S142 can be reduced, and the processing time also can be shortened.

As explained above, according to the condition definition apparatus 10 and 18 (FIGS. 1 and 5), the damage image data (inspection object data) is (are) used as input to easily and quickly obtain damage class data corresponding to the damage image data. Therefore, the damages (inspection object) shown by the damage image data (inspection object data) can be easily and quickly defined.

Some or all of the above example embodiments may be described as follows, but are not limited to the following.

Note 1: A condition definition apparatus including one or more processors for defining a condition of an inspection object.
the one or more processors are configured to: accept first inspection object data showing an image of a first inspection object, summary text data explaining a summary of a condition of the inspection object in text, and detailed text data explaining details of the condition of the inspection object in text;
generate an image feature vector showing features of the image shown by the first inspection object data from data of the accepted first inspection object;
generate a summary feature vector showing the summary of the features of the condition of the inspection object shown by the summary text data from the accepted summary text data; generate a detailed feature vector showing details of the condition of the inspection object shown by the detailed text data from the accepted detailed text data;
generate an integrated feature vector by integrating the generated summary feature vector and the detailed feature vector; and
generate inspection object class data used to define the condition of the inspection object from the integrated feature vector.
Note 2: The condition definition apparatus according to note 1, wherein the condition definition apparatus is configured to: accept first inspection object data showing an image of a first inspection object, and one or more sets of the summary text data and the detailed text data; and
generate one or more sets of the summary feature vector and the detailed feature vector corresponding to the first inspection object data.
Note 3: The condition definition apparatus according to note 1 or 2, wherein the one or more processors are further configured to: adjust an image feature extraction parameter used to generate the summary feature vector, a summary feature extraction parameter used to generate the summary feature vector, and a detailed feature extraction used to generate the detailed feature vector, so as to maximize a similarity between the generated image feature vector and the integrated feature vector.
Note 4: The condition definition apparatus according to note 3, wherein the one or more processors are further configured to store the integrated feature vector, the inspection object class data, and the image feature vector in association with each other.
Note 5: The condition definition apparatus according to any one of notes 1 to 4, wherein the one or more processors are further configured to:
accept second inspection object data showing an image of a second inspection object;
generate an image feature vector from the accepted second inspection object data showing features of the image shown by the second inspection object data; and
obtain the inspection object class data corresponding to the generated image feature vector.
Note 6: The condition definition apparatus according to any one of notes 1 to 5, wherein the one or more processors are further configured to obtain an image feature vector showing the image features of the second inspection object data, and one or more inspection object class data corresponding to the image feature vector having a similarity equal to or greater than a predetermined threshold value.
Note 7: The condition definition apparatus according to any one of notes 1 to 6, wherein the condition of the inspection object comprises damage to the inspection object.
Note 8: The condition definition apparatus according to any one of notes 1 to 7, wherein the summary text data is one prepared by an expert on the inspection object and qualitatively shows the features of damage to the inspection object.
Note 9: A condition definition method comprising:
accepting first inspection object data showing an image of a first inspection object, summary text data explaining a summary of a condition of the inspection object in text, and detailed text data explaining details of the condition of the inspection object in text;
generating an image feature vector showing features of the image shown by data of the first inspection object from the accepted first inspection object data;
generating a summary feature vector showing the summary of the features of the condition of the inspection object shown by the summary text data from the accepted summary text data, generating a detailed feature vector showing details of the condition of the inspection object shown by the detailed text data from the accepted detailed text data;
generating an integrated feature vector by integrating the generated summary feature vector and the detailed feature vector; and
generating inspection object class data used to define the condition of the inspection object from the integrated feature vector.
Note 10: The condition definition method according to note 9, further comprising:
accepting first inspection object data showing an image of a first inspection object, and one or more sets of the summary text data and the detailed text data; and
generating one or more sets of the summary feature vector and the detailed feature vector corresponding to the first inspection object data.
Note 11: The condition definition method according to note 9, further comprising: adjusting an image feature extraction parameter used to generate the summary feature vector, a summary feature extraction parameter used to generate the summary feature vector, and a detailed feature extraction parameter used to generate the detailed feature vector, so as to maximize a similarity between the generated image feature vector and the integrated feature vector.
Note 12: The condition definition method according to note 11, further comprising:
storing the integrated feature vector, the inspection object class data, and the image feature vector in association with each other.
Note 13: A computer readable storage medium storing a condition definition program that causes a computer to execute processes comprising:
accepting first inspection object data showing an image of a first inspection object, summary text data explaining a summary of a condition of the inspection object in text, and detailed text data explaining details of the condition of the inspection object in text;
generating an image feature vector showing features of the image shown by data of the first inspection object from the accepted first inspection object data;
generating a summary feature vector showing a summary of features of the condition of the inspection object shown by the summary text data from the accepted summary text data;
generating a detailed feature vector showing details of the condition of the inspection object shown by the detailed text data from the accepted detailed text data; generating an integrated feature vector by integrating the generated summary feature vector and the detailed feature vector; and
generating inspection object class data used to define the condition of the inspection object from the integrated feature vector.
Note 14: The computer readable storage medium according to note 13, wherein the processes further comprising:
accepting first inspection object data showing an image of a first inspection object, and one or more sets of the summary text data and the detailed text data; and
generating one or more sets of the summary feature vector and the detailed feature vector corresponding to the first inspection object data.
Note 15: The computer readable storage medium according to note 13, wherein the processes further comprising:
adjusting an image feature extraction parameter used to generate the summary feature vector, a summary feature extraction parameter used to generate the summary feature vector, and a detailed feature extraction parameter used to generate the detailed feature vector, so as to maximize a similarity between the generated image feature vector and the integrated feature vector.
Note 16: The computer readable storage medium according to note 15, wherein the processes further comprising:
storing the integrated feature vector, the inspection object class data, and the image feature vector in association with each other.
Note 17: The computer readable storage medium according to note 16, wherein the processes further comprising:
accepting second inspection object data showing a n image of a second inspection object;
generating an image feature vector from the accepted second inspection object data showing features of the image shown by the second inspection object data; and
obtaining the inspection object class data corresponding to the generated image feature vector.
Note 18: The computer readable storage medium according to note 17, wherein the processes further comprising:
obtaining an image feature vector showing the image features of the second inspection object data, and one or more inspection object class data corresponding to the image feature vector having a similarity equal to or greater than a predetermined threshold value.
Note 19: The computer readable storage medium according to note 13, wherein the condition of the inspection object comprises damage to the inspection object.
Note 20: The computer readable storage medium to note 13, wherein the summary text data is prepared by an expert on the inspection object and qualitatively shows the features of damage to the inspection object.
It goes without saying that combinations of respective modes according to the notes, or any combination of elements described in respective aspects and example embodiments (including the non-selection of some elements) can be made by those skilled in the art at any time in accordance with the basic concept of the present disclosure.

The disclosures of the above cited patent document is incorporated herein by reference. Within the framework of the entire disclosure of the present invention (including the scope of the claims), and further based on the basic technical ideas, modifications and adjustments of the embodiments and examples are Further, within the framework of the entire possible. disclosure of the present invention, various combinations and selections (including partial deletions) of the various disclosed elements (including each element of each claim, each element of each embodiment or example, each element of each drawing, etc.) are possible. In other words, the present invention naturally includes various modifications and corrections that a person skilled in the art would be able to achieve in accordance with the entire disclosure and technical ideas, including the scope of the claims. In particular, the numerical ranges described in this document should be interpreted as specifically describing any numerical value or small range included within the range, even if not otherwise specified. Furthermore, the disclosures of the above cited documents are deemed to be included in the disclosures of this application, which may be used in part or in whole in combination with the descriptions in this document as part of the disclosure of the present invention, in accordance with the spirit of the present invention, as necessary.

### REFERENCE SIGNS LIST

10, 18 Condition Definition Apparatus
100 Image Feature Extraction Part
102 Summary Feature Extraction Part
104 Detailed Feature Extraction Part
106, 180 Integrated Feature Vector Generation Part
108, 182 Similarity Data Generation Part
110, 184 Machine Learning Part
112 Damage Class Database
114 Image/Class Display Part
186 Inspection Object Class Database

What is claimed is:

1. A condition definition apparatus defining a condition of an inspection object comprising one or more processors, wherein the one or more processors are configured to:
accept first inspection object data showing an image of a first inspection object, summary text data explaining a summary of a condition of the inspection object in text, and detailed text data explaining details of the condition of the inspection object in text;
generate an image feature vector showing features of the image shown by data of the first inspection object from the accepted first inspection object data;
generate a summary feature vector showing a summary of features of the condition of the inspection object shown by the summary text data from the accepted summary text data;
generate a detailed feature vector showing details of the condition of the inspection object shown by the detailed text data from the accepted detailed text data;
generate an integrated feature vector by integrating the generated summary feature vector and the detailed feature vector; and
generate inspection object class data used to define the condition of the inspection object from the integrated feature vector.

2. The condition definition apparatus according to claim 1, wherein the condition definition apparatus is configured to:
accept first inspection object data showing an image of a first inspection object, and one or more sets of the summary text data and the detailed text data; and
generate one or more sets of the summary feature vector and the detailed feature vector corresponding to the first inspection object data.

3. The condition definition apparatus according to claim 1, wherein the one or more processors are further configured to:
adjust an image feature extraction parameter used to generate the summary feature vector, a summary feature extraction parameter used to generate the summary feature vector, and a detailed feature extraction parameter used to generate the detailed feature vector, so as to maximize a similarity between the generated image feature vector and the integrated feature vector.

4. The condition definition apparatus according to claim 3, wherein the one or more processors are further configured to:
store the integrated feature vector, the inspection object class data, and the image feature vector in association with each other.

5. The condition definition apparatus according to claim 4, wherein the one or more processors are further configured to:
accept second inspection object data showing a n image of a second inspection object;
generate an image feature vector from the accepted second inspection object data showing features of the image shown by the second inspection object data; and
obtain the inspection object class data corresponding to the generated image feature vector.

6. The condition definition apparatus according to claim 5, wherein the one or more processors are further configured to:
obtain an image feature vector showing the image features of the second inspection object data, and one or more inspection object class data corresponding to the image feature vector having a similarity equal to or greater than a predetermined threshold value.

7. The condition definition apparatus according to claim 1, wherein the condition of the inspection object comprises damage to the inspection object.

8. The condition definition apparatus according to claim 1, wherein the summary text data is prepared by an expert on the inspection object and qualitatively shows the features of damage to the inspection object.

9. A condition definition method comprising:
accepting first inspection object data showing an image of a first inspection object, summary text data explaining a summary of a condition of the inspection object in text, and detailed text data explaining details of the condition of the inspection object in text;
generating an image feature vector showing features of the image shown by data of the first inspection object from the accepted first inspection object data;
generating a summary feature vector showing a summary of features of the condition of the inspection object shown by the summary text data from the accepted summary text data,
generating a detailed feature vector showing details of the condition of the inspection object shown by data of the detailed text from the accepted detailed text data;
generating a n integrated feature vector by integrating the generated summary feature vector and the detailed feature vector; and
generating inspection object class data used to define the condition of the inspection object from the integrated feature vector.

10. The condition definition method according to claim 9, further comprising:
accepting first inspection object data showing an image of a first inspection object, and one or more sets of the summary text data and the detailed text data; and
generating one or more sets of the summary feature vector and the detailed feature vector corresponding to the first inspection object data.

11. The condition definition method according to claim 9, further comprising:
adjusting an image feature extraction parameter used to generate the summary feature vector, a summary feature extraction parameter used to generate the summary feature vector, and a detailed feature extraction parameter used to generate the detailed feature vector, so as to maximize a similarity between the generated image feature vector and the integrated feature vector.

12. The condition definition method according to claim 11, further comprising:
storing the integrated feature vector, the inspection object class data, and the image feature vector in association with each other.

13. A computer readable storage medium storing a condition definition program that causes a computer to execute processes comprising:
accepting first inspection object data showing an image of a first inspection object, summary text data explaining a summary of a condition of the inspection object in text, and detailed text data explaining details of the condition of the inspection object in text;
generating an image feature vector showing features of the image shown by data of the first inspection object from the accepted first inspection object data;
generating a summary feature vector showing summary of features of the condition of the inspection object shown by the summary text data from the accepted summary text data;
generating a detailed feature vector showing details of the condition of the inspection object shown by the detailed text data from the accepted detailed text data;
generating a n integrated feature vector by integrating the generated summary feature vector and the detailed feature vector; and
generating inspection object class data used to define the condition of the inspection object from the integrated feature vector.

14. The computer readable storage medium according to claim 13, wherein the processes further comprising:
accepting first inspection object data showing an image of a first inspection object, and one or more sets of the summary text data and the detailed text data; and
generating one or more sets of the summary feature vector and the detailed feature vector corresponding to the first inspection object data.

15. The computer readable storage medium according to claim 13, wherein the processes further comprising:
adjusting an image feature extraction parameter used to generate the summary feature vector, a summary feature extraction parameter used to generate the summary feature vector, and a detailed feature extraction parameter used to generate the detailed feature vector, so as to maximize a similarity between the generated image feature vector and the integrated feature vector.

16. The computer readable storage medium according to claim 15, wherein the processes further comprising:
storing the integrated feature vector, the inspection object class data, and the image feature vector in association with each other.

17. The computer readable storage medium according to claim 16, wherein the processes further comprising:
accepting second inspection object data showing an image of a second inspection object;
generating an image feature vector from the accepted second inspection object data showing features of the image shown by the second inspection object data; and
obtaining the inspection object class data corresponding to the generated image feature vector.

18. The computer readable storage medium according to claim 17, wherein the processes further comprising:
obtaining an image feature vector showing the image features of the second inspection object data, and one or more inspection object class data corresponding to the image feature vector having a similarity equal to or greater than a predetermined threshold value.

19. The computer readable storage medium according to claim 13, wherein the condition of the inspection object comprises damage to the inspection object.

20. The computer readable storage medium according to claim 13, wherein the summary text data is prepared by an expert on the inspection object and qualitatively shows the features of damage to the inspection object.
